(19) United States
(12) Patent Application Publication
(10) Pub. No.: US 2026/0179423 A1
(43) Pub. Date: Jun. 25, 2026

(54) USER MANAGEMENT SYSTEM

(71) Applicant: TOYOTA JIDOSHA KABUSHIKI KAISHA, Aichi-ken (JP)

(72) Inventor: Pritish DEBASIS, Tokyo-to (JP)

(21) Appl. No.: 19/401,363

(22) Filed: Nov. 26, 2025

(30) Foreign Application Priority Data
Dec. 20, 2024 (JP) 2024-225792

(51) Int. Cl. G07C 9/32

(52) U.S. Cl. CPC G07C 9/32

(57) ABSTRACT

A user management system managing one or more users who use one or more rooms. The user management system is configured to execute a detection process to detect an action performed in a room without identifying which user performed the action, to record event data, which associates the action detected by the detection process with a timestamp, and to execute a first identification process. The first identification process includes determining whether the detected action corresponds to a specific action associated with a user, and setting a specific flag indicating that the user performed the detected action to the event data, when the detected action corresponds to the specific action.

### CROSS REFERENCE TO RELATED APPLICATION

This application claims priority to Japanese Patent Application No. 2024-225792 filed on Dec. 20, 2024, the entire contents of which are incorporated by reference herein.

### TECHNICAL FIELD

The present disclosure relates to a user management system that manages a user who uses one or more rooms.

### BACKGROUND ART

Patent Literature 1 discloses an action detection device that detects actions of a person using a camera. The action detection device identifies a person passing through a gate by referring to a face image using camera images captured by the camera. The action detection device tracks the person using the camera image and detects features of the person's action.

### LIST OF RELATED ART

Patent Literature 1: Japanese Patent Publication No. 2011-034357

### SUMMARY

Consider managing one or more users using one or more rooms. In order to grasp the behavior of each user in detail and achieve proper user management, user identification is required. However, always capturing an image of the user with a camera is undesirable from the viewpoint of privacy protection.

The purpose of the present disclosure is to provide a technique for realizing user management while taking privacy protection into account.

A first aspect relates to a user management system managing a first to a Pth user (P is an integer of one or more) who use a first to a Nth room (N is an integer of one or more). The user management system includes processing circuitry and a database. The processing circuitry is configured to:
execute a detection process to detect an action performed in an ith room (i=any of 1 to N), without identifying which user performed the action;
record event data, which associates the action detected by the detection process with a timestamp, in the database; and
execute a first identification process.

The first identification process includes:
determining whether the detected action corresponds to a pth specific action associated with a pth user (p=1 to P), and
setting a pth specific flag indicating that the pth user performed the detected action to the event data, when the detected action corresponds to the pth specific action.

The user management system according to the present disclosure selectively uses the detection process that detects a user without identifying the user and the first identification process that identifies the user who performed an action based on the specific action performed by the user. The user management system can execute the first identification process on past actions based on the chronological order represented by the database. As a result, no device that directly identifies individuals, such as cameras, is required. That is, the user management system can grasp the behavior of the user while taking into account the viewpoint of privacy protection.

### BRIEF DESCRIPTION OF DRAWINGS

FIG. 1 is a schematic diagram showing an overview of a user management system.

FIG. 2 is a flowchart illustrating a flow of a process related to the user management system.

FIG. 3 is a schematic diagram showing some examples of a re-anonymization process.

FIG. 4 is a schematic diagram illustrating an outline of a movement determination process.

FIG. 5 is a schematic diagram showing an example of an indirect user identification process.

FIG. 6 is a schematic diagram illustrating a part of a database that records actions detected on a certain day.

FIG. 7 is a schematic diagram showing a part of a database related to actions recorded on another day.

FIG. 8 is a schematic diagram showing a part of a database related to actions recorded on yet another day.

FIG. 9 is a schematic diagram for explaining an example of a specifying process with learning.

FIG. 10 is a block diagram illustrating an example configuration of the user management system.

### DETAILED DESCRIPTION

Referring to the attached drawings, embodiments of the present disclosure will be described.

### 1. User Management System

### 1-1. Main Configuration

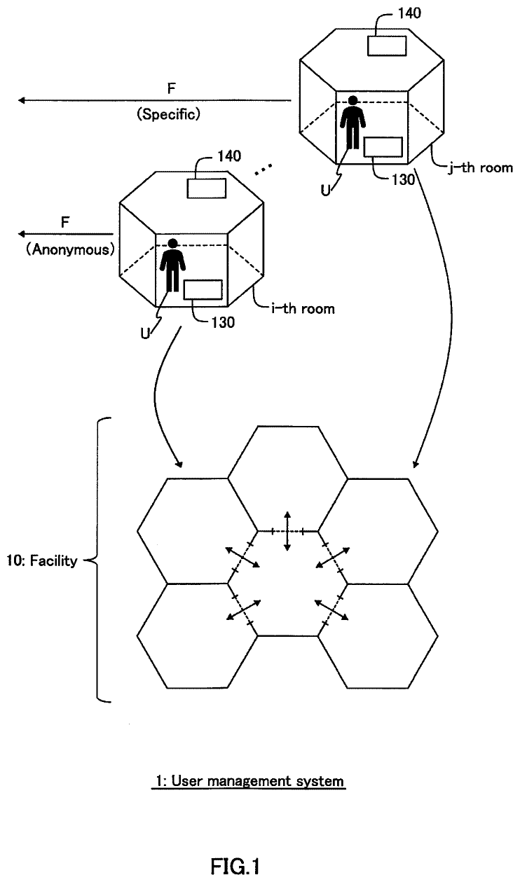

FIG. 1 is a schematic diagram illustrating an overview of a user management system 1. The user management system 1 manages a first to a Nth rooms (N being an integer of one or more) used by a first to a Pth user (hereinafter, “user U”. P being an integer of one or more). The first to the Nth rooms are configured so as to allow movement between them via corridors and other rooms. The user management system 1 is typically applied to a space formed by multiple private rooms and used by multiple specific users (such as apartments, offices, etc.).

Each of the first to Nth rooms is equipped with a user detection unit 130 and a user identification unit 140.

The user management system 1 executes a detection process to detect a user U present in a room where the user detection unit 130 is installed. The detection process is solely a process for detecting the presence of a person (user U), and does not identify who the detected person is. The user management system 1 sets an “anonymous flag” to the user detected by the detection process. The user detection unit 130 includes, for example, a human sensor such as an infrared sensor or a wireless sensing device. Wireless sensing is a mechanism for detecting an object by sensing variations in wireless communication radio waves caused by the radio waves being blocked by the object. In this embodiment, for convenience of explanation, a user detected by the detection process in the i-th room (i=any one of 1 to N) is defined as “a first user U-1”. In other words, the detection process detects the first user U-1 present in the i-th room and performs a process of assigning an anonymous flag to the user.

Various sensors are utilized in the detection process. The sensors are included in a user detection unit 130. The sensors are attached in various locations. For example, by attaching pressure sensors to a bed, a desk, a chair, etc., it is possible to detect actions such as waking up, sleeping, sitting, and standing performed by the user U. The detection process is a process that detects an action performed by the user U and thereby detects the presence of the user U. In other words, the detection process can be referred to as an action detection process that detects actions, or as a user detection process that detects the presence of the user U.

The user management system 1 determines whether the first user U-1, to whom an anonymous flag has been set, has performed a “specific action”. The specific action is an action for identifying each user U. Examples of the specific operation include physical actions (such as sitting in a specific location, raising both hands, etc.), powering on a predetermined electronic device (for example, a PC), and device operations such as logging into a specific system using electronic devices. When the specific action associated with the first user U-1 is detected, the user management system 1 identifies who the user is by assigning a “first specific flag” to the first user U-1, to whom an anonymous flag has been assigned. Hereinafter, a process of assigning a specific flag to identify the user U is referred to as a “user identification process.” The first user U-1 performs the first specific action in a first room of the jth room (where j is any one of 1 to N) and is identified by the user identification process.

The detection process and the user identification process may be executed in the same room or in different rooms. That is, the user U detected by the detection process may move to another room and be identified by performing the specific action in the destination room.

The user management system 1 acquires information related to the anonymous flag and the specific flag as flag information F. The user management system 1 comprehensively manages the received flag information F. Specifically, the user management system 1 manages the number of the users U present in each room and the status of the users U entering and exiting each room based on the flag information F.

This embodiment takes up a case where the user management system 1 is applied to facility 10 as shown at the bottom of FIG. 1. The facility 10 is formed by aggregating hexagonal rooms, and the central room is accessible to and from any of the other rooms. That is, each room of the facility 10 is configured to be accessible via the central room. The facility 10 merely illustrates an example to which the user management system 1 is applied, and the number, shape, arrangement, etc. of the rooms are not limited to the examples shown in the present embodiment.

### 1-2. Flow of the Process

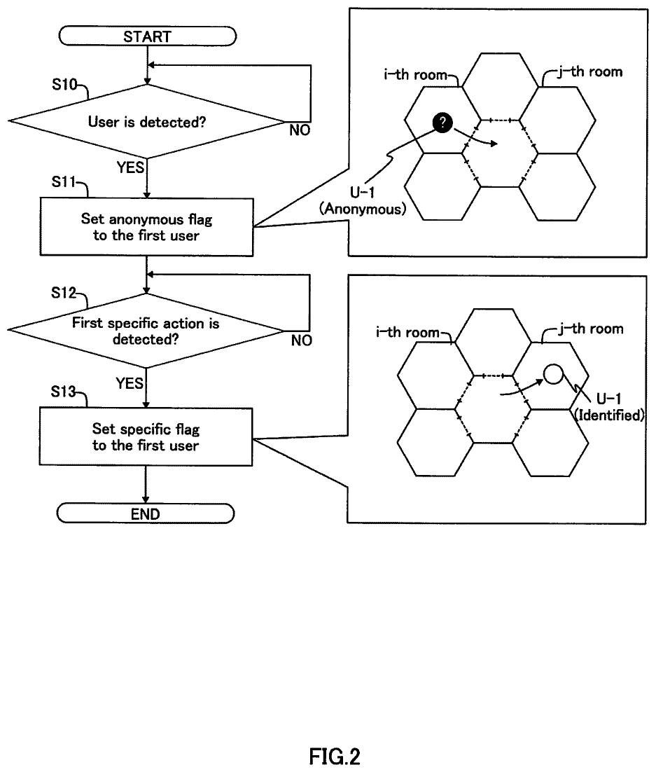

FIG. 2 is a flowchart showing the flow of the process of the user management system 1. The right portion of this figure schematically illustrates the state of the facility 10 during a series of steps.

In step S10, the user management system 1 executes the detection process in the i-th room. When a user is detected (S10; Yes), the process proceeds to step S11. When no user is detected (S10; No), the process repeats step S10.

In step S11, the user management system 1 assigns an anonymous flag to the first user U-1 detected in the i-th room. At this point, the user detection unit 130 recognizes that the first user U-1 exists in the i-th room but has not specifically identified who the first user U-1 is. Next, the process proceeds to step S12.

In step S12, the user management system 1 determines whether or not a first specific action has been performed in the j-th room. When a first specific action is performed (S12; Yes), the process proceeds to step S13. When the first specific action is not performed (S12; No), the process repeats step S12.

In step S13, the user management system 1 sets the first specific flag to the first user U-1. At this point, the user identification unit 140 can identify who the first user U-1 detected in the i-th room is. Thereafter, the process ends.

### Effect

The user management system 1 selectively uses the “detection process” that detects the user U without identifying the user U, and the “user identification process” that identifies the user U based on a specific action performed by the user U. This series of process does not require a device that directly identifies an individual, such as cameras or microphones. The sensor used in the user management system 1 only needs to detect the occurrence of an action. Also, when detecting the specific action in the user identification process, information that can directly identify the individual (such as videos captured by cameras or sounds captured by microphones) is not required. That is, the user management system 1 enables the acquisition of information regarding the movement paths and behavior patterns of the user U while taking into consideration the privacy of the user U.

### 2. Other Related Processes

### 2-1. Re-Anonymization Process

Consider a case where multiple users U exist. In this case, when multiple users U-1 to M (where M is an integer greater than or equal to 2) including the first user U-1 with a first identification flag set exist in the k-th room (k=1 to N), the first identification flag set to the first user U-1 should be updated to an anonymous flag. Hereinafter, the process of updating a specific flag to an anonymous flag is referred to as the “re-anonymization process.”

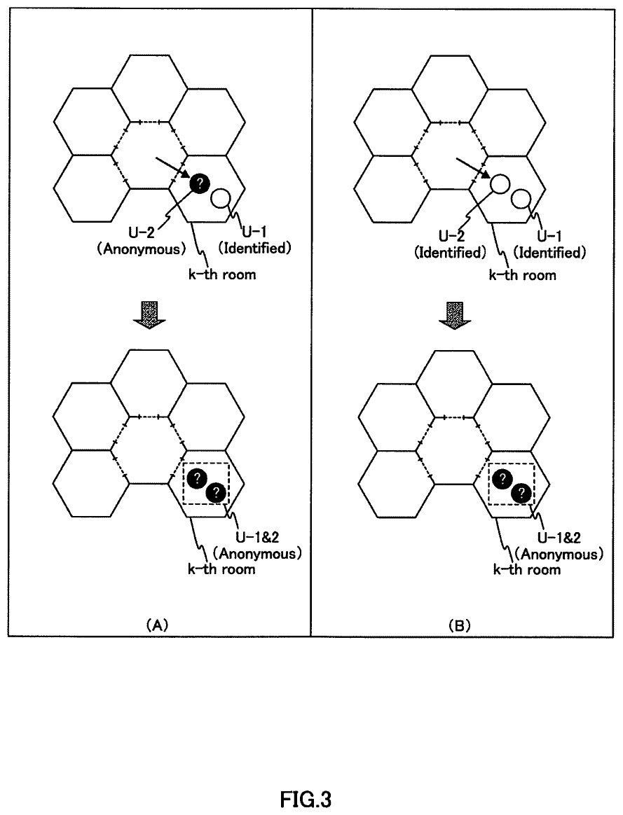

FIG. 3 is a schematic diagram illustrating several examples of the re-anonymization process. In FIG. 3 (A) shows a situation where a second user U-2 with an anonymous flag enters the k-th room where the first user U-1 is present. Since the user management system 1 manages the user U based on the number of flags in each room, when two users exist in the k-th room, it is impossible to identify which one is the specified first user U-1. Therefore, in such a case, the first identification flag of the first user U-1 should be updated to an anonymous flag so that two users in the k-th room are in an anonymous state. The re-anonymization process contributes to preventing mis-correspondence between two types of flags: the anonymous flag and the specific flag. As shown in part (B) of FIG. 3, when the second user U-2, who is assigned with the second specific flag, enters the k-th room, re-anonymization process is performed not only on the first user U-1 but also on the second user U-2.

### 2-2. Movement Determination Process

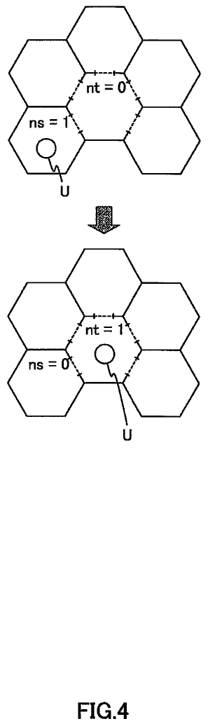

Consider the case where the first to Nth rooms include two adjacent rooms. The user management system 1 may execute a “movement determination process” to determine whether a user located in one of two adjacent rooms has moved to the other of the two adjacent rooms. FIG. 4 is a schematic diagram illustrating an overview of the movement determination process. Assuming that the two adjacent rooms are the s-th room and the t-th room (s, t=1 to N), the movement determination process corresponds to a process of determining whether a user U has moved between the s-th room and the t-th room. The movement determination process is executed based on a s-th user number ns and a t-th user number nt. The s-th user number ns represents the number of users present in the s-th room. In other words, the s-th user number ns can be said to be the number of flags in the s-th room (the total of anonymous flags and specific flags). Similarly, the t-th user number nt represents the number of users present in the t-th room. In the example of FIG. 4, the user U moves from the s-th room to the t-th room. When a user U exists in the s-th room, the s-th user number ns is 1, and the t-th user number nt is 0. When a user U moves to the t-th room, the s-th user number ns is 0, and the t-th user number nt is 1. Since the s-th room and the t-th room are adjacent to each other, the changes in the number of the s-th user number ns and the t-th user number nt accompanying the movement of the user U are expected to occur within a short period. In general terms, the user management system 1 determines that there has been movement of the user U between the s-th room and the t-th room when both the s-th user number ns and the t-th user number nt change within a predetermined time.

The information regarding the s-th user number ns and the t-th user number nt can be referred to as adjacent user number information. That is, the movement determination process is a process for determining whether a user U existing in one of two adjacent rooms has moved to the other of the two adjacent rooms based on the adjacent user number information. By repeatedly performing the movement determination process, the user management system 1 can track the user U within the facility 10.

### 2-3. Indirect User Identification Process

In addition to the method based on the specific action described in Section 1-1, the user identification process may also indirectly identify the first user U-1. Such a user identification process is especially referred to as “an indirect user identification process.”

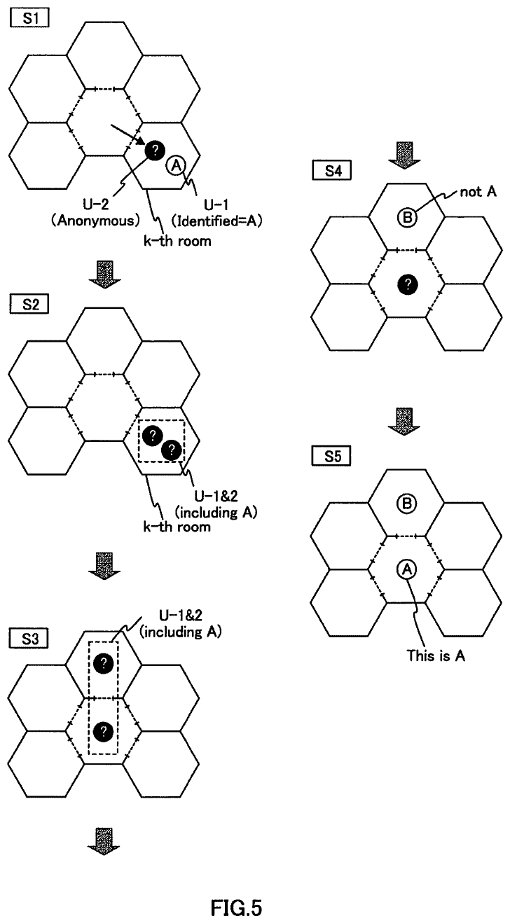

FIG. 5 is a schematic diagram illustrating an example of the indirect user identification process. S1 and S2 are in the same situation as in part (A) of FIG. 3. In S1, it is assumed that the first user U-1 is associated with “A,” which is a user ID corresponding to the first specific flag. The user ID mentioned here is sufficiently a mere identification symbol and does not need to be linked to personal information such as a face image, address, telephone number, email address, etc.

In S2, the re-anonymization process is executed, and the first user U-1 and the second user U-2 are recognized by the user management system 1 as two anonymous users. At this time, the user management system 1 records that “A” is included among two anonymous users.

Subsequently, two anonymous users including “A” move independently and reach a state S3. At this time, if the movement determination process has been executed, the user management system 1 can track two anonymous users including “A”. However, it is not possible to determine which of the two anonymous users is “A”.

In step S4, suppose one of the two anonymous users is identified as “B” (that is, not “A”) by the user identification process. At this time, since the other of the two anonymous users (the one that is not “B”) is uniquely determined as “A”, the user management system 1 can indirectly specify “A”. At this time, the user management system 1 can specify “A” without determining the first identification process.

The indirect user identification process is applicable not only when there are two anonymous users but also in the general case of multiple users. In general terms, the indirect user identification process is applied when, after an anonymization flag is assigned to the first user U-1 by the re-anonymization process in the k-th room, the second to the M-th are assigned to all users from the second to the M-th users.

### 3. User Process Using Database

The user management system 1 may further include a database DB. The user management system 1 can efficiently execute the user identification process by referring to a database DB. In the database DB, an action detected by the detection process is recorded in association with its time when the action was performed. The data in which an action and its timestamp are associated are referred to as “event data”. The longer the user management system 1 is operated for, the more event data accumulates in the database DB. Below, an identification process using the database DB will be described. Here, the facility 10 is assumed to be a family house. In the following description, it is assumed that the first to third rooms are adjacent to a kitchen, and the kitchen and a living room are adjacent to each other.

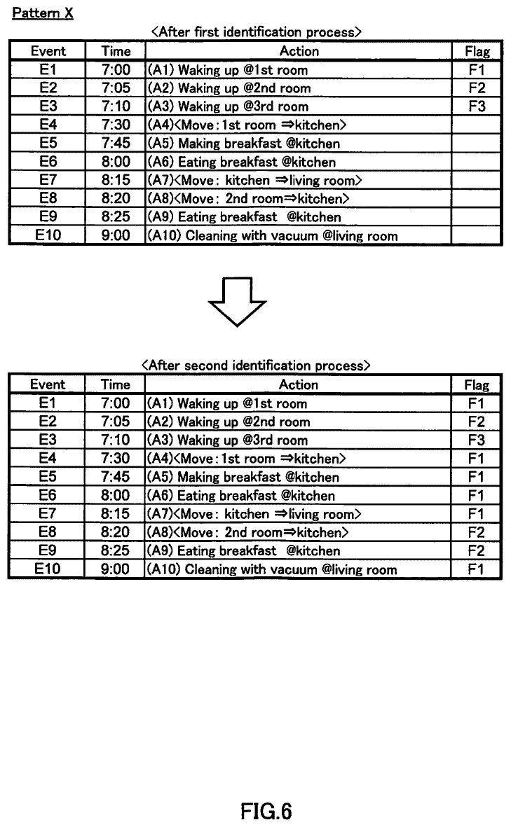

FIG. 6 is a schematic diagram showing a part of the database DB that records actions detected on a certain day. For the sake of explanation, each action is marked with a number. The outlines of the actions are as described below. The event data E1 to E10 are labeled as data including event A1 to A10. The action of moving between each room is determined by the

aforementioned movement determination process. Each user behavior pattern shown in FIG. 6 is defined as Pattern X, assuming that the first to the Pth users use the facility 10.
<Action A1> Waking up in the first room
<Action A2> Waking up in the second room
<Action A3> Waking up in the third room
<Action A4> Moving from the first room to the kitchen
<Action A5> Making breakfast in the kitchen
<Action A6> Eating breakfast in the kitchen
<Action A7> Moving from the kitchen to the living room
<Action A8> Moving from the second room to the kitchen
<Action A9> Eating breakfast in the kitchen
<Action A10> Cleaning the living room with a vacuum cleaner

### 3-1. First Identification Process

The user management system 1 executes the first identification process. In the first identification process, the user management system 1 determines whether each action recorded in the database DB corresponds to a specified action associated with each user. When the recorded action corresponds to a specific action, a specific flag is attached to the event data. This process, except for utilizing the database DB, is the same as the user identification process described in Section 1-1. The upper part of FIG. 6 shows the contents of the database DB after the first identification process. The event data E1, which includes Action A1, is assigned a first specific flag F1 indicating that the first user U-1 performed the Action. The event data including Action A2 is assigned with a second specific flag F2 indicating that the second user U-2 performed the action. The event data including Action A3 is assigned with a third specific flag F3 indicating that the third user performed the action. Since Actions A1 to A3 are all actions of waking up in a room, they are detected, for example, by a sensor attached to a bed. Furthermore, the user who performed the action is identified by the correspondence between the wake-up action and the room in which that action was detected. Since the user management system 1 cannot specify which user performed Actions A4 to A10, the corresponding event data E4 to E10 are not assigned to a specific flag. Hereinafter, a user performing each action is referred to as an “actor.”

In general terms, the first identification process includes determining whether an action detected by the detection process corresponds to any specific action associated with the pth user (where p is any of 1 to P). The first identification process further includes, when a detected action corresponds to the pth specific action, adding a pth specific flag indicating that the pth user performed the action to the event data. Event data to which the pth specific flag has been added by the first identification process is referred to as the pth specific event data. Event data to which the pth specific flag has not been added by the first identification process is referred to as anonymous event data. That is, in FIG. 6, Actions A1 to A3 correspond to the first to third specific event data, respectively. On the other hand, actions A4 to A10 are anonymous event data.

### 3-2. Second Identification Process

Following the first identification process, the user management system 1 executes the second identification process. The second identification process is a process of assigning a specific flag to the anonymous event data based on the timestamp indicated by the database DB. The lower part of FIG. 6 shows the contents of the database DB after the second identification process. For example, in Action A4, it is defined that only the first user U-1, who was originally in the first room, can move from the first room to the kitchen. Accordingly, the user management system 1 assigns the first specific flag F1 to Action A4. Since it is established that action A4 was performed by the first user U-1, it is also established that the subsequent Actions A5 to A7 are actions performed by the first user U-1. This is because, during the relevant period of time, there are no other users in the kitchen besides the first user U-1. Action A8 is established to be performed by the second user U-2 based on the same logic as Action A4. Furthermore, it is established that Action A9, following Action A8, is performed by the second user U-2. The action of eating breakfast is common between Action A5 and Action A8, but at the time of process A8, no one except the second user U-2 is in the kitchen (the first user U-1 has already moved to the living room). Therefore, action A8 is determined to be an action performed by the second user U-2. Action A10 is determined to be performed by the first user U-1, who moved to the living room in Action A7. The user management system 1 assigns a specific flag to a determined anonymous event data with respect to the actor. Further, since a movement originating from the third room has not been detected (recorded), it is determined that the third user has not moved out from the third room.

In the second specific process, the user management system 1 determines whether the p-th user has performed a certain action based on the time series indicated by the database DB including the p-th specific event data. Furthermore, if it is determined that the p-th user has performed a certain action, the user management system 1 assigns a p-th specific flag to the anonymous event data. In other words, in the example of FIG. 6, the user management system 1 assigns the first specific flag F1 to the event data E4 to E7 and E10, and assigns the second specific flag F2 to the event data E8 to E9.

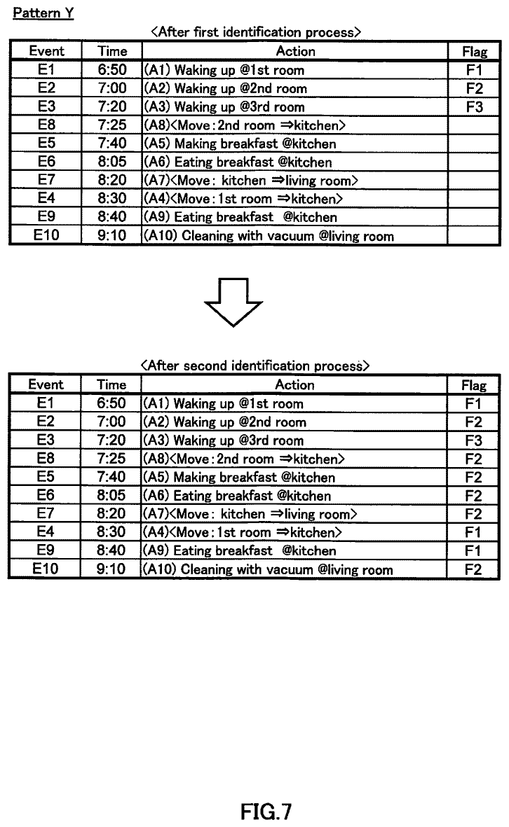

FIG. 7 is a schematic diagram showing a portion of the database DB related to actions recorded on a different day from Pattern X. The behavior pattern of each user shown in FIG. 7 is defined as pattern Y. In pattern Y, the timing of Actions A4 and A8 are swapped relative to pattern X. In this case, the actors of each action determined by the second specific process differ from those in the pattern X. Specifically, Actions A5 to A8 and A10 are determined as actions by the second user U-2, and Actions A4 and A9 are determined as actions by the first user U-1. In this case, the user management system 1 assigns the second specific flag F2 to the event data E5 to E8 and E10, and assigns the first specific flag F1 to the event data E4 and E9.

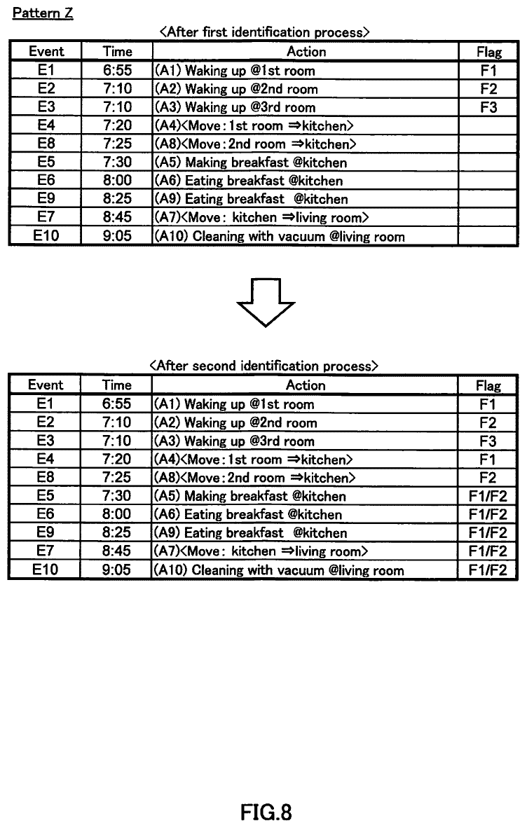

In the second identification process, an actor is not always determined for all actions. FIG. 8 is a schematic diagram showing a portion of the database DB related to actions recorded on another different day. The behavioral patterns of each user shown in FIG. 8 are defined as pattern Z. In pattern Z, two actions of moving to the kitchen (A4 and A8) are recorded immediately after Action A3. In this case, since two users exist in the kitchen simultaneously, the user management system 1 cannot determine the correspondence between the two users and the first user U-1 and the second user U-2. That is, a user management system 1 executes a process of re-anonymization. Therefore, regarding actions A5, A6, and A9 performed in a kitchen, the actor is not determined. Therefore, the user management system 1 does not assign a specified flag to event data after 7:30. In addition, even in this situation, it can be determined that the actions performed after 7:30 are conducted by either the first user U-1 or the second user U-2 (the possibility of the third user, who has not moved from the third room, being the actor is excluded). Therefore, even when the actor is not uniquely determined as in pattern Z, the user management system 1 is somewhat beneficial for partly grasping behavior patterns.

### 3-3. Feature Extraction of Actions

The user management system 1 can execute the first identification process more efficiently by extracting features of each action. The following describes that process.

For example, in pattern X (see FIG. 6), it has been confirmed that Actions A5 and A10 were performed by the first user U-1. The user management system 1 can extract features of actions A5 and A10 performed by the first user U-1. The features of each action are extracted based on information acquired from a sensor. Features of action A5 includes, for example, a period of time for making breakfast, the required time for making the breakfast, a speed and acceleration of moving cooking utensils, whether or not using a stove, etc. Alternatively, a sensor installed may measure the load applied to the kitchen floor, and this measured value may be regarded as body weight for feature extraction. Features of action A10 includes, for example, a period of time for using the vacuum cleaner, the duration for using the vacuum cleaner, a speed and acceleration of operating the vacuum cleaner, etc. That is, the user management system 1 extracts features specific to action A5 and action A10 performed by the first user U-1 from data of pattern X. In other words, the user management system 1 learns the gestures and habits associated with Action A5 performed by the first user U-1, as pattern X is repeated. Similarly, in the case of pattern Y (see FIG. 7), the user management system 1 extracts (learns) features specific to Actions A5 and A10 performed by the second user U-2.

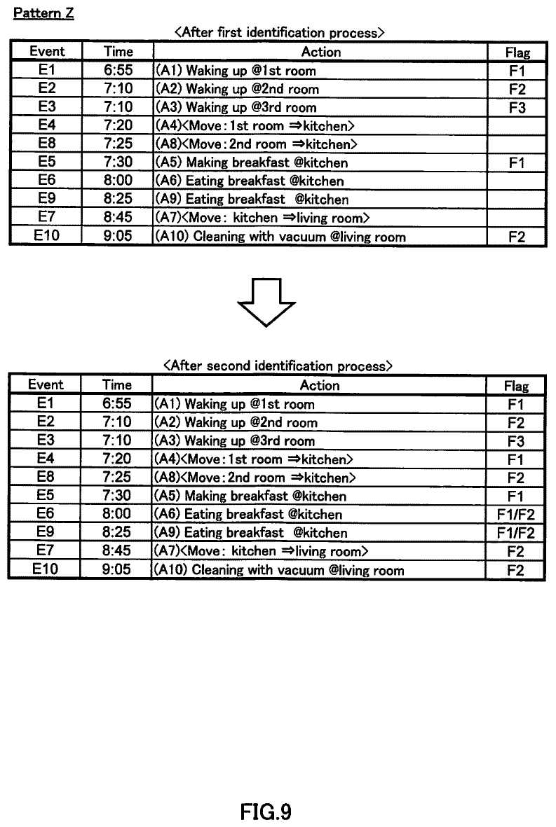

The user management system 1 can utilize the learned features in the first identification process. The first identification process that does not includes feature learning can be referred to as a “non-learning identification process,” and the first identification process that includes feature learning can be referred to as a “learning identification process.” Here, the difference between these two types of process will be described. FIG. 9 is a schematic diagram for explaining an example of the learning identification process. The contents of the database DB correspond to pattern Z (the same as in FIG. 8). FIG. 8 is an example of the non-learning identification process, and FIG. 9 is the learning identification process. In the case of process without learning, the actors of action A5 and action A10 are not determined, and therefore, the event data E5 and E10 are not assigned to a specific flag. On the other hand, in the case of the learning identification process (FIG. 9), the actors of Actions A5 and A10 can be determined. This is because the user management system 1 learns the unique features of the actions performed by each user in pattern X and pattern Y. In FIG. 9, the user management system 1 determines the actor of action A5 to be the first user U-1 and the actor of action A10 to be the second user U-2.

That is, the user management system 1 extracts features of the actions included in the anonymous event data to which the p-th specific flag has been assigned by the second specific process. The user management system 1 further uses the extracted features as features of the p-th specific action in the first identification process. The longer the user management system 1 is operated for, the more event data is accumulated, and the learning of actions performed by each user progresses. As a result, the efficiency with which the user management system 1 identifies each user in the first identification process gradually improves. Examples of features of the extracted actions include the timestamp indicating when the action was performed, the place where the action was performed, the duration of the action, and mechanical parameter related to the action. The mechanical parameter refers to a parameter such as speed, acceleration, load, etc., acquired by a sensor attached to a device or equipment.

Furthermore, in the second identification process, based on the time series, it is determined that the room movement action A7, followed by Action A10, is performed by the second user U-2. Action A6 and A9 have not determined the actor, but by further feature learning may enables discrimination. However, even in the state shown in FIG. 9, the movement paths of two users can be grasped. In other words, it is identified that the actor of Action A6 is one of the first user U-1 or the second user U-2, and the actor of Action A9 is the other user. Therefore, in pattern Z, the user management system 1 can determine that the first user U-1 moved from the first room to the kitchen, and that the second user U-2 moved from the second room to the living room via the kitchen.

### 3-4. Unknown Event Data

In the user management system 1, there may be event data to which a specific flag is not set even after the first identification process and the second specific process. For example, imagine a person enters inside from outside the facility 10, moves to a kitchen, and then goes outside. The user management system 1 detects the series of actions and records them in the database DB. However, in this case, the user management system 1 basically cannot identify the actor of that series of actions. The user management system 1 may add an unknown flag indicating that the actor is unidentified to such event data. Event data to which the unknown flag has been added is hereinafter referred to as “unknown event data.” Since the actor of the unknown event data may be an intruder, the user management system 1 may notify the administrator of the user management system 1 and the user U when the unknown event data has accumulated.

In another case, consider a situation where a friend of the user U regularly visits the facility 10 and cooks in the kitchen. The user management system 1 initially treats this cooking action as unknown event data. As described above, since the user management system 1 can extract features of this cooking action, if this friend repeatedly performs the cooking action, the system can recognize this cooking action as a specific action and execute the first identification process. That is, the user management system 1 eventually regards this friend as a new user.

As described above, the user management system 1 executes the user identification process for the past actions based on the time series indicated by the database DB. Thereby, the user management system 1 can identify the actor of each action without using information such as videos or audios that directly identifies individuals. A configuration in which the user management system 1 uses the database DB is particularly effective when the user management system 1 does not include a camera. The timing at which the user identification processes using the database DB (i.e., the first identification process and the second identification process) are executed is not limited. Typically, these identification processes are regularly performed according to arbitrarily set intervals (e.g., every month, every quarter, every six months, etc.).

### 4. Configuration

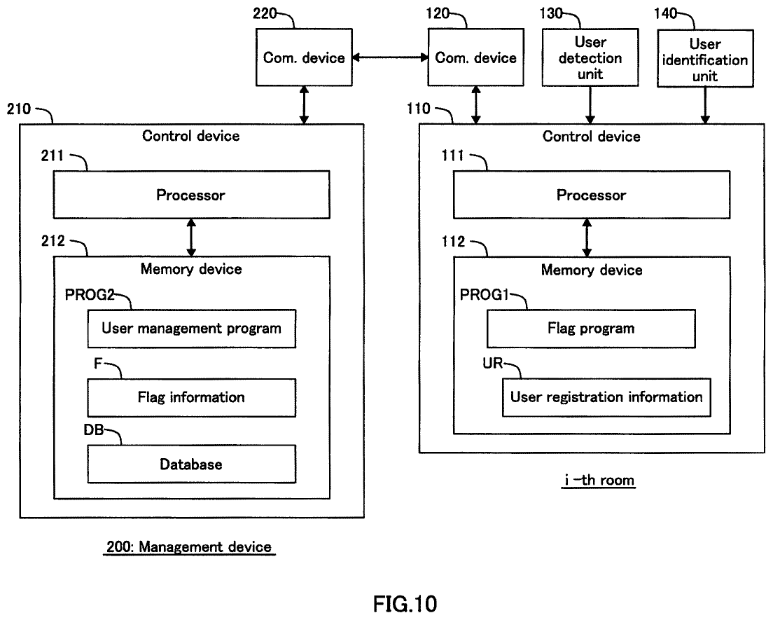

FIG. 10 is a block diagram showing an example configuration of the user management system 1.

### 4-1. Example Configuration of i-th Room

The right side of FIG. 10 shows an example configuration of the i-th room. Since the configurations of the first through the N-th rooms are common, the i-th room is shown here as a representative.

The control device 110 is a computer that controls each device installed in the i-th room. The control device 110 includes one or more processors 111 (hereinafter, simply referred to as the processor 111) and one or more memory devices 112 (hereinafter, simply referred to as the memory device 112). The processor 111 executes various processes. For example, the processor 111 includes a CPU (central processing unit). The processor 111 can also be referred to as process circuitry. The memory device 112 stores various information. As the memory device 112, a volatile memory, a non-volatile memory, a hard disk drive (HDD), a solid-state drive (SSD), and the etc. are exemplified.

The flag program PROG1 is a computer program executed by the processor 111. The function of the control device 110 is realized by cooperation between the processor 111, which executes the flag program PROG1, and the memory device 112. For example, the detection process and the user identification process described above function by the control device 110 executing the flag program PROG1. The flag program PROG1 is stored in the memory device 112. Alternatively, the flag program PROG1 may be recorded on a computer-readable recording medium.

The control device 110 executes the detection process and the user identification process. The control device 110 acquires information necessary for the detection process via the user detection unit 130, and acquires information necessary for the user identification process via the user identification unit 140. In addition, the control device 110 communicates with a management device 200 via a communication device 120. Flag information F, which is obtained as the result of the detection process and the user identification process, is transmitted from the control device 110 to the management device 200.

User registration information UR is information necessary for the user identification process. The user registration information UR is in a format associating each user ID of the user U with data related to a specific action corresponding to the user ID.

### 4-2. Example Configuration of Management Device

The control device 210 is a computer that controls the management device 200. The control device 210 includes one or more processors 211 (hereinafter simply referred to as the processor 211) and one or more memory devices 212 (hereinafter simply referred to as the memory device 212). The processor 211 executes various processes. For example, the processor 211 includes a CPU (central processing unit). The processor 211 can also be referred to as process circuitry. The memory device 212 stores various information. Examples of the memory device 212 include volatile memory, non-volatile memory, an HDD (hard disk drive), an SSD (solid state drive), etc.

A user management program PROG2 is a computer program executed by the processor 211. The function of the control device 210 is realized through cooperation between the processor 211 executing the user management program PROG2 and the memory device 212. The user management program PROG2 is stored in the memory device 212. Alternatively, the user management program PROG2 may be recorded on a computer-readable recording medium.

The flag information F is information related to anonymous flags and specific flags for each room. The flag information F includes information about when, in which room, and what type of flag was assigned. The management device 200 can grasp the number of users U present in each room, the period of time when users U tend to gather, etc. based on flag information F. The flag information F is used as the adjacent user number information in the movement determination process.

The database DB records the actions of the user U in chronological order. The database DB is used for analyzing the movement paths and behavior patterns of the user U in the facility 10.

The control device 210 communicates with the communication device 120 on the side of the i-th room via a communication device 220.

### 4-3. Others

It should be noted that the management device 200 may execute at least a part of the detection process or the user identification process. For example, when information acquired by the user detection unit 130 or the user identification unit 140 is sent from the control device 110 to the management device 200, the management device 200 can execute at least a part of the detection process or the user identification process.

In general terms, one or more processors execute various process including the detection process, the user identification process, the movement determination process, and the re-anonymization process.

What is claimed is:

1. A user management system managing a first to a Pth user (P is an integer of one or more) who use a first to a Nth room (N is an integer of one or more), the user management system comprising processing circuitry and a database, wherein
the processing circuitry is configured to:
execute a detection process to detect an action performed in an ith room (i=any of 1 to N), without identifying which user performed the action;
record event data, which associates the action detected by the detection process with a timestamp, in the database; and
execute a first identification process, wherein
the first identification process includes:
determining whether the detected action corresponds to a pth specific action associated with a pth user (p=1 to P), and
setting a pth specific flag indicating that the pth user performed the detected action to the event data, when the detected action corresponds to the pth specific action.

2. The user management system according to claim 1, wherein
pth specific event data includes the event data to which the pth specific flag is set by the first specific process,
anonymous event data includes the event data to which the pth specific flag is not set by the first specific process, and
the processing circuitry is further configured to execute a second identification process, wherein
the second identification process includes:
determining whether it is uniquely established that the pth user performed the detected action based on time series indicated by the database including the pth specific event data; and
setting the pth specific flag to the anonymous event data when it is uniquely established that the pth user performed the detected action.

3. The user management system according to claim 1, wherein
the processing circuitry is further configured to:
extract a feature of the detected action; and
use the extracted feature as a feature of the pth specific action in the first specific process.

4. The user management system according to claim 3,
the feature of the detected action includes at least one of:
a timestamp indicating when the detected action was performed;
a place where the detected action was performed;
a duration of the detected action; or
mechanical parameter related to the detected action.

5. The user management system according to claim 1, wherein
the user management system does not include a camera.
